(19) United States
(12) Patent Application Publication
(10) Pub. No.: US 2005/0263533 A1
(43) Pub. Date: Dec. 1, 2005

(54) Dispensing container

(76) Inventors: Anne Elizabeth Haggerty, Belleville, NJ (US); Jeffrey Shawn Gibb, Boonton, NJ (US); Jean-Marc Richeux, Vourles (FR); Allen McDowell, Rock Valley (GB)

Correspondence Address: STITES & HARBISON PLLC, 1199 NORTH FAIRFAX STREET, SUITE 900, ALEXANDRIA, VA, 22314, US

(21) Appl. No.: 10/856,770

(22) Filed: Jun. 1, 2004

(51) Int. Cl. B65D 6/16; B65D 8/14; B65D 6/28; B65D 6/12; G07F 11/00

(52) U.S. Cl. 221/2

(57) ABSTRACT

A dispensing container for bead products includes a lid and a bottom part. Pulling back the lid exposes the interior of the container where the bead products are located. The internal structures of the container includes a step and may further include a recess, and funnel structures at the front of the bottom part provide for feeding the beads one at a time or in a stream when the lid is pulled back.

### FIELD OF THE INVENTION

This invention relates to dispensing containers, and in particular it relates to a container for dispensing bead products.

### BACKGROUND OF THE INVENTION

The term “bead products” refers to small objects of every kind including mints or other candies, tablets, pills and the like, whether spherical, square, flat, oval or of any other shape, provided that the product is a shape which allows it to roll freely or slid within the container, especially from the main storage area thereof to the vicinity of the dispensing opening.

Dispensers for such bead products are known for example as shown in U.S. Pat. Nos. 1,988,134; 4,354,619; 4,502,612; 5,123,539; 5,513,774; 6,068,126 and German Publication No. DE 32 15 520 A1.

Notwithstanding the existence of previously known dispensing containers of the type for dispensing bead products, a need exists for new and improved dispensing containers.

### BRIEF SUMMARY OF THE INVENTION

It is a purpose of the present invention to provide new and improved dispensing containers for bead products.

A purpose of the present invention is to provide new dispenser containers of the present type which have a sleek ergonomic feel when held in the hand and is easily operable to dispense products by pulling back a lid to reveal the bead products in the container.

The dispensing containers of the present invention can be designed to dispense only one bead product at a time or they can be designed such that when the lid is pulled back they dispense a stream of bead products. In accordance with the present invention, when constructed to dispense one bead product at a time, the internal structure in the form of a step with a recess so as to permit a single bead product to be delivered into a position just under the front of the lid while the lid is closed, whereupon after the lid is slid back, only that one bead product will be delivered and the container holds back the other products.

In another arrangement, a more open passageway can be provided in the internal construction of the dispensing container such that when the lid is pulled back an unrestricted passageway is provided for the flow of bead products from the interior of the container out the opening thereof so as to dispense a stream of bead products.

In accordance with one embodiment, a container of a generally rectangular shape includes a lid which rides over a bottom part which includes a front wall, side walls and a rear wall. This embodiment has an internal construction which permits dispensing one bead product at a time. The interior construction includes a raised step in the vicinity where the lid opens with a recess formed in the raised step. In the closed condition, any number of bead products can ride up on the step, with only one received in the recess. In this embodiment, when sliding back the lid to open the container, the lid will engage all bead products on the step except for the one in the recess and pull them back into the main body of the container, leaving that one bead product to be dispensed until the lid is again closed so that another bead product can locate itself in the recess.

Another embodiment can be constructed with a funnel from the main part of the container to the recess so that when the lid is opened, a stream of bead products can be delivered through the funnel, to the recess, and out of the container.

Thus, it is an object of the present invention to provide new and improved dispenser containers for bead products.

It is another object of the present invention to provide improved dispensing containers for bead products which have an improved ergonomic feel.

These and other objects of the present invention will become apparent from the detailed description which follows of the preferred embodiments.

### BRIEF DESCRIPTION OF THE DRAWINGS

There follows a detailed description of preferred embodiments of the present invention, to be read together with the accompanying drawings, wherein:

FIG. 1 is a top perspective view of the present invention;

FIG. 2 is a top perspective view similar to FIG. 1 but wherein the top is shown as a transparent for purposes of illustration;

FIG. 3 is a longitudinal cross sectional view of FIGS. 1 and 2;

FIG. 4 is a view similar to FIG. 2 but showing the dispensing container in a partially opened condition;

FIG. 5 is a longitudinal cross sectional view of FIG. 4;

FIG. 6 is a view similar to FIGS. 2 and 3 but showing the dispensing container in its fully opened position;

FIG. 7 is a longitudinal sectional view of FIG. 6;

FIG. 8 is a cross sectional view taken along line 8-8 of FIG. 2;

FIG. 9 is a top perspective view similar to FIG. 6, showing a modified dispensing container in the opened position;

FIG. 10 is a longitudinal cross sectional view of FIG. 9, but showing the dispensing container in the closed position;

FIG. 11 is a longitudinal cross sectional view of FIG. 9, but showing the dispensing container in a partially opened condition;

FIG. 12 is a longitudinal cross sectional view of FIG. 9; and

FIG. 13 is a bottom perspective view of the bottom part of the dispensing container of FIG. 9.

### DETAILED DESCRIPTION OF THE PREFERRED EMBODIMENTS

Referring now to the drawings, like elements are represented by like numerals throughout the several views.

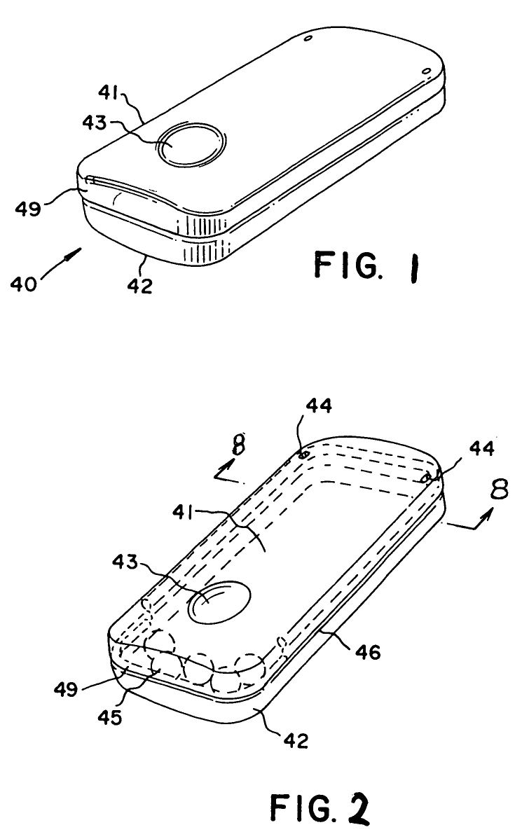

FIGS. 1-8 which show a dispensing container 40. Referring to FIG. 1, the generally rectangular dispensing container 40 includes a lid 41 and a bottom part 42. The specific material forms no part of the present invention. However, most likely the dispensing container would have an opaque top and an opaque bottom. However, primarily for purposes of illustration, FIGS. 2, 4 and 16 show a transparent lid 41 in order to better illustrate the internal parts and the operation of this dispensing container. The lid 41 includes a thumb depression 43 and a pair of pips 44 to lock the lid in the closed position. Bead products 45 are shown in the various views. The bottom part 42 includes a side wall forming a groove 46 and a curled top 47 which is present along the rear and most of the front of the bottom part. The lid 41 includes a rail 48 which is received in and rides along the groove 46. The groove 46 also extends around the rear of the dispensing container whereat it receives a rail portion 48 of the lid.

The lid 41 includes a front wall 49 which serves a function to be described below. The front of the dispensing container 40 includes a raised step 50 formed at the front of the bottom part 42, which raised step includes a recess 51 for receiving a single bead product 45.

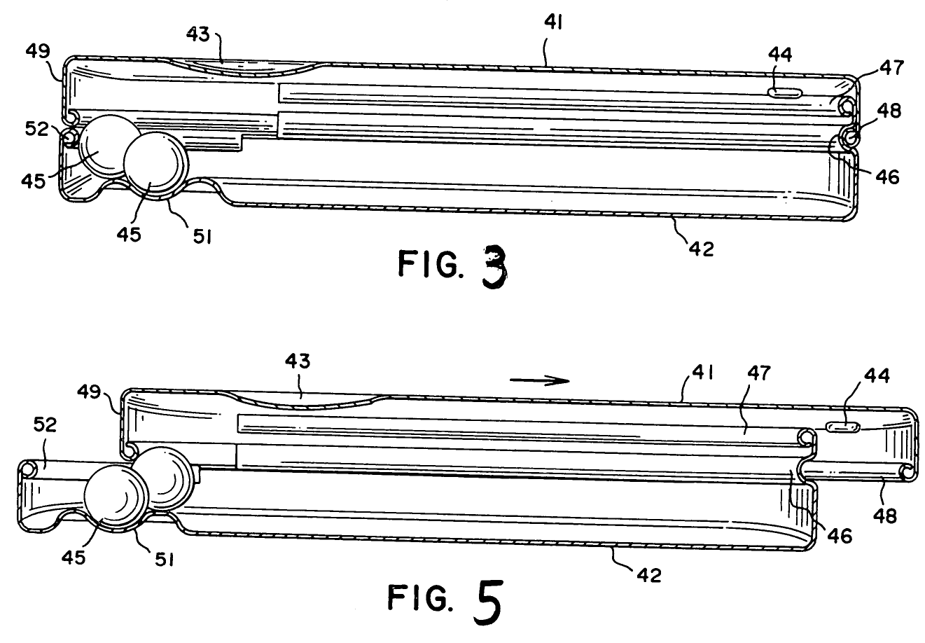

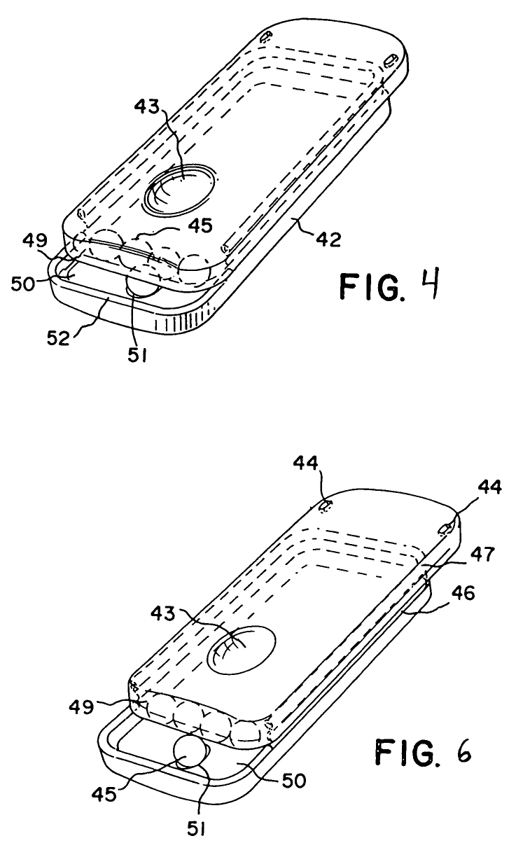

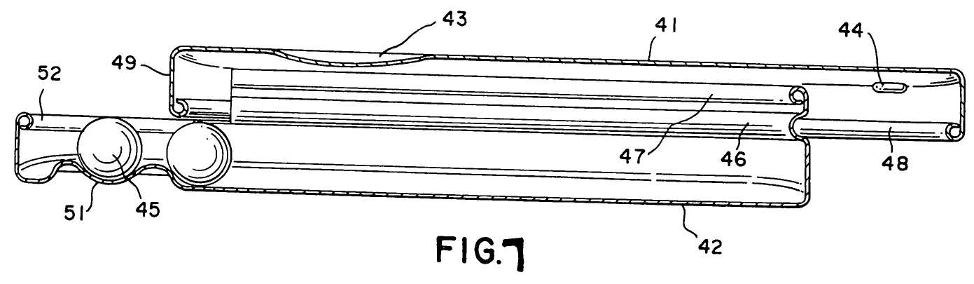

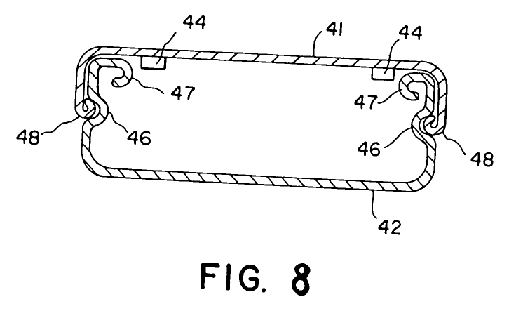

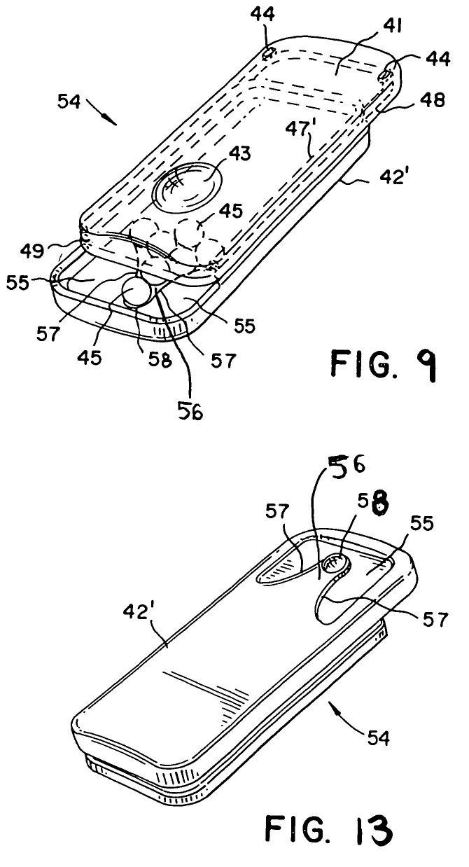

Referring to all of the figures, but in particular, FIGS. 3, 5 and 7, the dispensing container 41 operates as follows. In the closed position, as shown in FIGS. 2 and 3, bead products can move freely all the way to the front of the container, up and over the raised step 50. At this time, a single bead product 45 will locate itself in the recess 51. Referring to FIGS. 4 and 5, when the user slides the lid back by grasping the container in one hand with his or her thumb in thumb depression 43 and starts moving the lid rearwardly, the front wall 49 of the lid 41 will move all bead products 45 rearwardly, off of the raised step 50. Referring in particular to FIG. 7, all bead products except the one in the recess 51 are prevented from moving forwardly until the lid is again closed. At this time the user will simply flip the dispensing container over to dispense the single bead product 45.

FIGS. 9-13 show a modification of FIGS. 1-8. In this embodiment the lid is unchanged and hence the same reference numerals are used as in FIGS. 1-8. The bottom part is modified only at the front. Therefore, identical elements use the same numeral, but with a prime [′]. The variation is shown toward the front of the bottom part.

The variation of FIGS. 9-13 is very similar to the embodiment of FIGS. 1-8 except that the front of the bottom part is constructed to dispense more than one bead product at a time before the lid is closed.

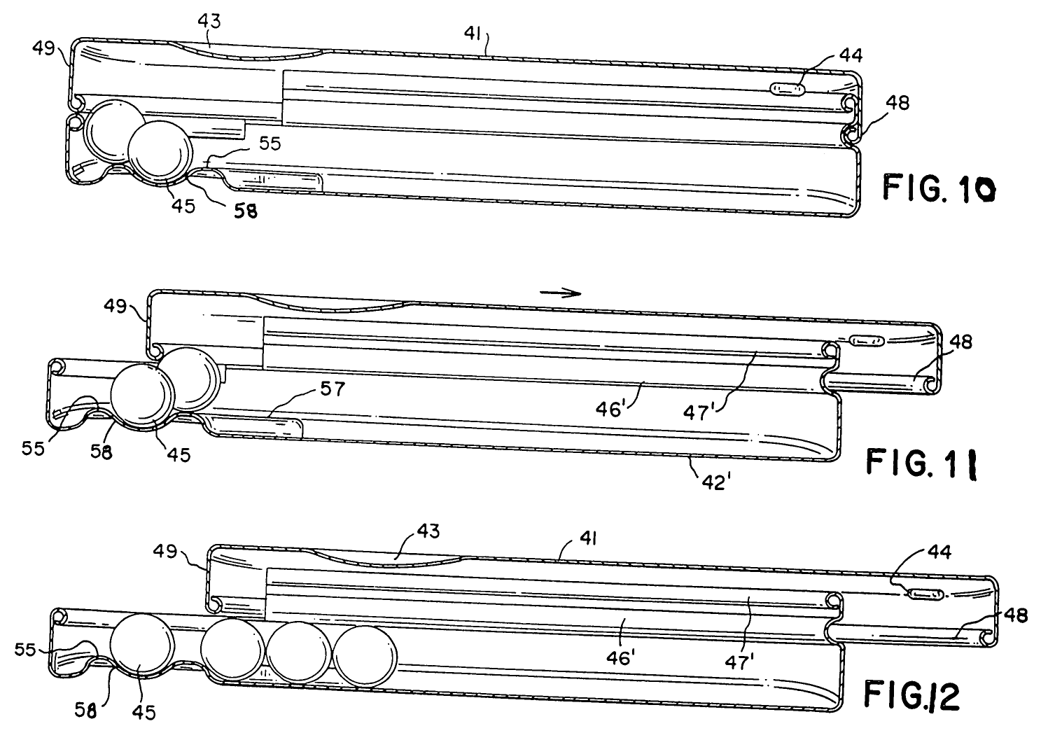

Referring to the dispensing container 54 of FIG. 9, the front of the bottom part 42′ includes a raised step 55 having a recess 56 with a slight dimple portion 58 which receives a single bead product 45. However, the back of the recess 56, instead of being up to the height of the step 55 is actually lowered down to the level of the remainder of the bottom part 42. This is shown in FIG. 13 which shows as a result of metal stamping, the opposite of the raised parts in the bottom part 42′, including a recess 56 in the raised step 55, behind which is a funnel 57.

In the operation of this embodiment, while the lid 41 is in the closed position, any number of bead products can collect on the step 55 in a manner similar to that shown in FIG. 2, wherein one bead 45 is received in the recess 56 and in particular, the dimple portion 58. Also similar to the embodiment of FIGS. 1-8, as the lid is pulled back, it pulls all of the bead products off of the step 55 except for the bead product 45 in the recess 56. The difference in this embodiment, however, is that the remaining bead products, instead of being held against being dispensed until the next time that the lid closes, form a queue behind the bead product in the recess 56 so that in use, after the user dispenses the product initially in the recess 56, the user can simply tilt the front of the dispensing container downwardly to allow another bead product to run down into the recess 56 and be dispensed. This process can continue indefinitely.

Although the invention has been described in considerable detail with respect to preferred embodiments, it will be apparent that the invention is capable of numerous modifications and variations, apparent to those skilled in the art, without departing from the spirit and scope of the invention.

1. A dispensing container for bead products, said container comprising:
a bottom part adapted to contain the bead products, said bottom part having a front potion of the bottom part formed with a raised step into which a recess is formed, said recess for receiving at least one bead product to be dispersed; and
a lid slidable relative to the bottom part to expose a portion of the interior of the container between the lid and the bottom part to dispense bead products, said lid having a downwardly projecting front wall which, as the lid is opening, pushes any bead products on the raised step into the interior of the container except for a bead product or products in the recess, such that when the lid is opened, the bead product or products in the recess can be dispensed.

2. The dispensing container according to claim 1, wherein the container is rectangular and the lid slides relative to the bottom part in the longitudinal direction.

3. The dispensing container according to claim 2, wherein the lid has sides which ride along grooves in the bottom part.

4. The dispensing container according to claim 3, wherein the height of the sides of the lid is essentially the same as the height of the side wall of the lower part beneath the groove.

5. The dispensing container according to claim 1, further comprising a reduced height funnel passage from the interior of the container, through the raised step to the recess, and wherein said downwardly projecting front wall pushes any bead products on the raised platform into the interior of the container except for a bead product in the recess and bead products in the funnel passage when the lid is opening, such that when the lid is opened, a stream of bead products can pass from the interior of the container into the funnel passage and into the recess to be dispensed, without closing the lid.

6. The dispensing container according to claim 5, wherein the container is rectangular and the lid slides relative to the bottom part in the longitudinal direction.

7. The dispensing container according to claim 6, wherein the lid has sides which ride along grooves in the bottom part.

8. The dispensing container according to claim 7, wherein the height of the sides of the lid is essentially the same as the height of the side wall of the lower part beneath the groove.

9. A rectangular container for bead products comprising a bottom part adapted to contain bead products and a lid slidable longitudinally relative to the bottom part to open one end of the container, the bottom part having a recess formed in the forward end thereof for receiving a bead product to be dispensed, the recess being formed in a raised step which surrounds the recess, and the lid having a front wall which, when the lid is opening, moves bead products on the raised step off of the raised step and into the interior of the container.

10. A rectangular container for bead products comprising a bottom part adapted to contain bead products and a lid slidable longitudinally relative to the bottom part to open one end of the container, the bottom part having a recess formed in the forward end thereof for receiving a bead product to be dispensed, the recess being formed in a raised step which surrounds the recess except for a funnel connecting the recess with the interior of the container, and the lid having a front wall, which when the lid is opening, moves bead products on the raised step off of the raised step and into the funnel or the interior of the container.

11. A dispensing container for dispensing only one bead product each time that the container is opened, comprising a lid and a matching bottom part forming an interior, the lid being slidable relative to the bottom part to expose a front area of the interior of the container, the bottom part having structure which allows only one bead to be delivered to said front area when the container is closed, and which prevents any bead product from being delivered to said front area when the lid is opened, said structure comprising a raised step in the vicinity of the front area which is raised except for a recess formed therein, the lid having a front wall which, while opening, moves any and all bead products on the raised step, except for the bead product in the recess, off of the raised step and into the interior of the container, and prevents any further bead from entering the recess while the lid is opened and permitting additional bead products to move onto the raised step and into the recess after the lid has been closed,
whereby each time that the lid is opened, the bead product in the front area, and no other bead, can be dispensed from the container.
